(19) United States
(12) Patent Application Publication
(10) Pub. No.: US 2023/0215611 A1
(43) Pub. Date: Jul. 6, 2023

(54) ASSEMBLED MAGNETIC INDUCTOR WITH INSULATING LAYER COMPONENT

(71) Applicant: Zenith Tek Inc., New Taipei (TW)

(72) Inventor: Mark Huang, TW (TW)

(21) Appl. No.: 17/568,053

(22) Filed: Jan. 4, 2022

(51) Int. Cl. H01F 17/04; H01F 27/34

(52) U.S. Cl. CPC H01F 17/043; H01F 27/346

(57) ABSTRACT

The present invention provides an assembled magnetic inductor with insulating layer component, and more particularly to printing, adhesion, or spray coating an insulating layer material on a pre-press molded surface of one of two internal metal components to cause an insulating layer to form on the outer surface thereof. Hence, an insulating layer between the two metal components is dispensed with in the assembly of the combination magnetic inductance, thereby further decreasing inductance of the assembly components, as well as reducing inter-component gaps and magnetic leakage, and acoustic noise.

### BACKGROUND OF THE INVENTION

### (a) Field of the Invention

The present invention relates to an assembled magnetic inductor, and more particularly to printing, adhesion, or spray coating an insulating layer material on a pre-press molded surface of one of two internal metal components to cause an insulating layer to form on the outer surface thereof, hereby decreasing amount of the assembly components, as well as reducing inter-component gaps and magnetic leakage, and acoustic noise.

### (b) Description of the Prior Art

As is well known, a traditional magnetic component or inductor uses a toroidal core, around the circumference of which is wound a single set or multiple sets of copper wire that generates a magnetic field when an electric current flows through, modifying the electric current and voltage value. However, in order to overcome the winding problem on the magnetic component of the prior art, currently, the industry is already gradually improving the structure by using an assembled magnetic inductor.

However, columnar assembled magnetic inductor products still have the problem of the leakage of magnetic lines of force that generate electromagnetic interference (EMI). Hence, to remedy the problem, a magnetic outer cover is additionally installed on the exterior of the columnar magnetic core of the prior art. Such a configuration is commonly referred to as a drum core type inductor, which has two major advantages compared to an unshielded magnetic component, including clearly providing an increase in the magnetic lines of force along the magnetic material and strengthening the output intensity of the entire magnetic field, as well as enabling the outer cover to channel the magnetic lines of force into the outer cover material, thereby reducing leakage of the magnetic lines of force.

Referring to FIG. 1, which shows a current, widely applied drum core or magnetic inductance, that is mainly assembled and formed from a magnetic core (11), magnetic outer covers (1, 2) provided with magnetic core outer cover grooves (12), two copper metal pieces (3, 4), and an insulating piece (5). In the assembly, the insulating piece (5) is placed between the two copper metal pieces (3, 4), the three being laminated together, which is then placed and bonded within the magnetic core outer cover grooves (12) of the magnetic outer covers (1, 2), thereby achieving the expected inductance effect.

However, It can be seen that the above-described assembled magnetic inductor has a great many components, which apart from increasing the manufacturing cost, will also naturally produce a large number of inter-component assembly gaps within the structure, generating a lot of vibrations from electromagnetic force and noise, and certainly leading to greater magnetic leakage, and acoustic noise.

### SUMMARY OF THE INVENTION

The clear shortcomings of an assembled magnetic inductor of the prior art provided the motivation for our research, and through investigation, innovation, experimentation, and application, our research team finally succeeded in developing the “assembled magnetic inductor with insulating layer component” of the present invention.

The main innovative concept of the present invention lies in printing, adhesion, or spray coating a layer of insulating material on one of the pre-pressed molded surfaces of one of the internal metal components of the assembled magnetic inductor, causing the surface to form an insulating layer. Accordingly, an additional insulating layer between the two metal components is dispensed with in the assembly of the combination magnetic inductance, thereby further decreasing inductance of the assembly components, as well as reducing inter-component gaps and magnetic leakage, and acoustic noise.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is an exploded elevational view of an assembled magnetic inductor of the prior art.

FIG. 2 is an exploded elevational view of an assembled magnetic inductor of the present invention.

FIG. 3 is an exploded elevational view of another embodiment of the assembled magnetic inductor of the present invention.

FIG. 4 is an exploded elevational view of yet another embodiment of the assembled magnetic inductor of the present invention.

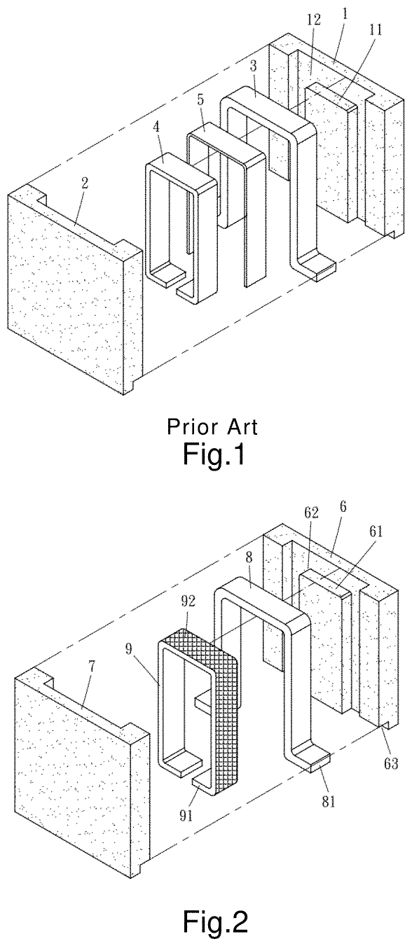

### DETAILED DESCRIPTION OF THE PREFERRED EMBODIMENTS

Referring to FIG. 2, which shows an assembled magnetic inductor with insulating layer component of the present invention, primarily comprising a set of symmetrical magnetic outer covers (6, 7), an outer copper piece (8), and an inner copper piece (9).

A magnetic core (61) and a magnetic core outer cover groove (62) formed with the shape of the periphery of the magnetic core (61) are provided in the inner surface of each of the aforementioned set of symmetrical magnetic outer covers (6, 7). Moreover, an output notch (63) is formed on each of the two sides of the lower edge of each of the magnetic core outer cover grooves (62).

The aforementioned outer copper piece (8) assumes an inverted U-shaped copper piece, the two bottom ends of which are bent to respectively form an extended bent conductive end (81).

The aforementioned inner copper piece (9) is similar in size to the aforementioned magnetic core (61) and assumes a frame-shaped copper piece; moreover, the outer surface thereof corresponds to the internal diameter of the outer inverted U-shaped copper piece (8). The two bottom ends of the inner copper piece (9) are respectively bent inwardly to form extended bent conductive ends (91). In addition, a layer of insulating material (92) is printed or adhered or spray coated on a pre-press molded outward facing surface of the inner copper piece (9) (excluding the bent conductive ends (91)).

When assembling, the internal diameter of the frame body of the inner copper piece (9) is positioned on the magnetic core (61) and inserted into the magnetic core outer cover groove (62) of either the magnetic outer cover (6) or the magnetic outer cover (7) and fixed therein. In addition, the internal diameter of the inverted U-shape of the outer copper piece (8) is positioned on the inner copper piece (9), thereby also inserting the outer copper piece (8) into the magnetic core outer cover groove (62) and fixedly laminating the configuration therein. Furthermore, the two conductive ends (81) on the two bottom ends of the outer copper piece (8) are respectively clasped within the output notches (63); the other symmetrical magnetic outer cover (6) or (7) is then used to cover and bond the configuration together with glue.

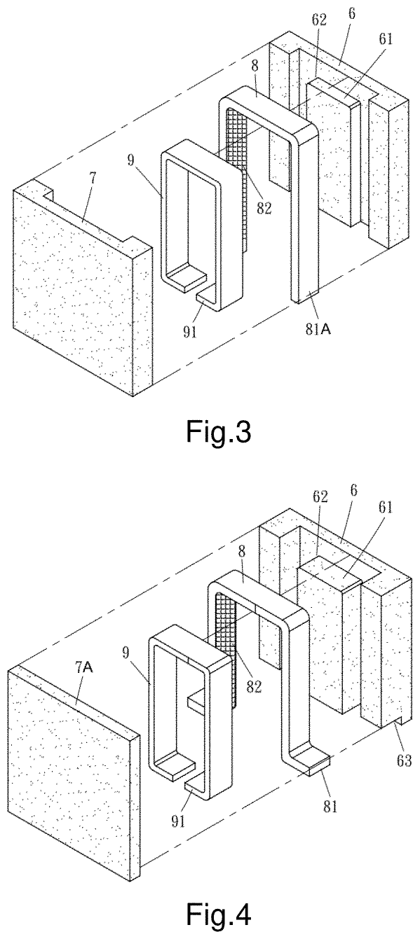

Referring to FIG. 3, which shows another embodiment of the present invention, wherein the bottom ends of the outer copper piece (8) of the first embodiment are configured with straight conductive ends (81A) rather than the bent conductive ends (81); moreover, the output notches (63) are also dispensed with.

An insulating layer (82) is provided on the inner surface or outer surface of the aforementioned outer copper piece (8), without disrupting an electrical connection between the bent conductive ends (81) or the straight conductive ends (81A) and a circuit board.

The aforementioned electrical connection of the bent conductive ends (81) or the straight conductive ends (81A) on the outer copper piece (8) with a circuit board can also be replaced and configured on the inner copper piece (9).

Referring to FIGS. 2 and 4, wherein FIG. 4 shows another embodiment of the present invention, wherein the magnetic core (61), the magnetic core outer cover groove (62), and the output notches (63) of the magnetic outer covers (6, 7) can be completely configured on just one of the magnetic outer covers (6 or 7), with the other magnetic outer cover (either 6 or 7) formed as a planar cover plate (7A).

Referring to FIGS. 3 and 4, which show two of the embodiments of the present invention, wherein the insulating layer (92) provided on the outward facing surface of the inner copper piece (9), as shown in FIG. 2, is replaced and provided instead on the inward facing surface of the outer copper piece (8), as shown in FIG. 4 (excluding the surfaces of the bent conductive ends (81)), and is used to serve as the insulating layer (82).

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An assembled magnetic inductor with insulating layer component, comprising a set of symmetrical magnetic outer covers (6, 7), an outer copper piece (8), and an inner copper piece (9);
a magnetic core (61) and a magnetic core outer cover groove (62) formed with a periphery of the magnetic core (61) are provided in an inner surface of each of the set of symmetrical magnetic outer covers (6, 7); an output notch (63) is formed on two sides of a lower edge of each of the magnetic core outer cover grooves (62);
the outer copper piece (8) assumes an inverted U-shaped copper piece, two bottom ends of which are bent to respectively form an extended bent conductive end (81);
the inner copper piece (9) is similar in size to the magnetic core (61) and assumes a frame-shaped copper piece; an outer surface thereof corresponds to an internal diameter of the outer inverted U-shaped copper piece (8); two bottom ends of the inner copper piece (9) are respectively bent inwardly to form extended bent conductive ends (91); a layer of insulating material (92) is printed or adhered or spray coated on a pre-press molded outward facing surface of the inner copper piece (9) (excluding the bent conductive ends (91));
when assembling, an internal diameter of a frame body of the inner copper piece (9) is positioned on the magnetic core (61) and inserted into the magnetic core outer cover groove (62) of either the magnetic outer cover (6) or the magnetic outer cover (7) and fixed therein; in addition, the internal diameter of the inverted U-shape of the outer copper piece (8) is positioned on the inner copper piece (9), thereby inserting the outer copper piece (8) into the magnetic core outer cover groove (62) and fixedly laminating the configuration therein; further, the two conductive ends (81) on the two bottom ends of the outer copper piece (8) are respectively clasped within the output notches (63); the other symmetrical magnetic outer cover (6) or (7) is then used to cover and bond the configuration together with glue.

2. The assembled magnetic inductor with insulating layer component according to claim 1, wherein the outer copper piece (8) is configured with straight conductive ends (81A) rather than the bent conductive ends (81); excluding the output notches (63).

3. The assembled magnetic inductor with insulating layer component according to claim 1, wherein the magnetic core (61), the magnetic core outer cover grooves (62), and the output notches (63) of the magnetic outer covers (6, 7) are completely configured on just one of the magnetic outer covers 6 or 7, with the other magnetic outer cover (either 6 or 7) formed as a planar cover plate (7A).

4. The assembled magnetic inductor with insulating layer component according to claim 1, wherein the insulating layer (92) provided on an outward facing surface of the inner copper piece (9) is replaced and instead provided on an inward facing surface of the outer copper piece (8) (excluding the surfaces of the bent conductive ends (81)), and is used to serve as an insulating layer (82).

5. The assembled magnetic inductor with insulating layer component according to claim 2, wherein the insulating layer (82) is provided on an inner surface or outer surface of the outer copper piece (8) without disrupting an electrical connection between the bent conductive ends (81) or the straight conductive ends (81A) thereof and a circuit board.
